(19) United States
(12) Patent Application Publication
(10) Pub. No.: US 2016/0349774 A1
(43) Pub. Date: Dec. 1, 2016

(54) DYNAMIC BIASING CIRCUITS FOR LOW DROP OUT (LDO) REGULATORS

(71) Applicant: TEXAS INSTRUMENTS INCORPORATED, Dallas, TX (US)

(72) Inventors: Sri Navaneethakrishnan Easwaran, Plano, TX (US); Vijayalakshmi Devarajan, Plano, TX (US)

(73) Assignee: TEXAS INSTRUMENTS INCORPORATED, Dallas, TX (US)

(21) Appl. No.: 14/930,906

(22) Filed: Nov. 3, 2015

Related U.S. Application Data
(60) Provisional application No. 62/166,773, filed on May 27, 2015.

(51) Int. Cl. G05F 1/56

(52) U.S. Cl. CPC G05F 1/56

(57) ABSTRACT

Dynamic biasing circuits for low drop out (LDO) regulators are described. In some embodiments, an electronic circuit may include a low drop out (LDO) regulator; and a biasing circuit coupled to the LDO regulator, the biasing circuit configured to: monitor a first electrical current and a second electrical current; select a greater of the first or second electrical currents; and provide the selected electrical current to the LDO regulator. In other embodiments, a method may include: providing a digital core and a low drop out (LDO) regulator coupled to the digital core, wherein the digital core is configured to operate in an active mode and in a standby mode; monitoring, via a current selector circuit coupled to the LDO regulator, a first current and a second current; selecting a greater of the first or second electrical currents; and providing the selected current as a biasing current to the LDO regulator.

### CROSS-REFERENCE TO RELATED APPLICATIONS

This application claims priority to U.S. Provisional Patent Application Ser. No. 62/166,773 titled “LOW DROP OUT REGULATORS WITH DYNAMIC BIASING CIRCUIT WITH SCALABLE DESIGN COEFFICIENTS” and filed on May 27, 2015, which is incorporated by reference herein.

### TECHNICAL FIELD

This specification is directed, in general, to electronic circuits, and, more specifically, to dynamic biasing circuits for low drop out (LDO) regulators.

### BACKGROUND

Integrated electronic devices often have multiple cores, such as low voltage (LV) digital cores and high voltage (HV) analog cores. In many cases, each core may be capable of operating in different power modes. For example, during normal operation, a digital core may transition from a low-power mode (e.g., standby mode) to a high-power mode (e.g., active mode), where the current consumption increases.

As the inventors hereof have recognized, a low drop out (LDO) regulator providing the voltage supply to the digital core should have low quiescent current during standby mode, where the load current on the digital core is ultra low (e.g., ˜100 nA). However, such an LDO should also be able to provide the required load current (e.g., ˜5 mA) with a good transient response during the digital core's active mode.

To address these, and other concerns, systems and methods described herein provide techniques for adapting biasing conditions on an LDO to achieve a low quiescent current during the standby mode, and also to provide good transient response during the active mode.

### SUMMARY

Dynamic biasing circuits for low drop out (LDO) regulators are described. In an illustrative, non-limiting embodiment, an electronic circuit may include a low drop out (LDO) regulator; and a biasing circuit coupled to the LDO regulator, the biasing circuit configured to: monitor a first electrical current and a second electrical current; select a greater of the first or second electrical currents; and provide the selected electrical current to the LDO regulator.

The electronic circuit may also include a digital core coupled to the LDO regulator and configured to receive a regulated supply voltage from the LDO regulator. For example, the digital core may be configured to operate in a standby mode and in an active mode such that, when the digital core is in the standby mode, it is configured to operate with the first electrical current, and when the digital core is in the active mode, it is configured to operate with the second electrical current. The first electrical current may be smaller than the second electrical current. The second electrical current may be of the order of 10 μA when the digital core is in the active mode, and approximately 0 A when the digital core is in the standby mode.

The biasing circuit may include a current selector circuit configured to receive the first electrical current and the second electrical current. The current selector circuit may be configured to output the greater of the first or second electrical currents as a bias current to the LDO regulator. The current selector circuit may be further configured to continuously monitor the first and second electrical currents before and after the digital core transitions between the standby mode and active modes.

In some cases, the current selector circuit may further comprise: a first current mirror configured to receive the first current; a second current mirror coupled to the first current mirror at a difference node and configured to receive the second current; a third current mirror coupled to the difference node and configured to receive a difference current between the first current and the second current; and a fourth current mirror configured to receive the second current and coupled to the third current minor at a summing node that adds the second current to the difference current if the first current is greater than the second current.

In another illustrative, non-limiting embodiment, an electronic device, may include a digital core; a low drop out (LDO) regulator coupled to the digital core; and a selector circuit coupled to the LDO regulator, the selector circuit configured to: monitor a first current and a second current; select a greater of the first or second currents; and provide the selected current as a biasing current to the LDO regulator.

In some cases, when the digital core is in a standby mode it is configured to operate with the first current, and when the digital core is in an active mode it is configured to operate with the second current. The first current may be smaller than the second current. The selector circuit may be further configured to continuously monitor the first and second currents before and after the digital core transitions between the standby mode and active modes.

The selector circuit may further include: a first current mirror configured to receive the first current; a second current mirror coupled to the first current mirror at a difference node and configured to receive the second current; a third current mirror coupled to the difference node and configured to receive a difference current between the first current and the second current; and a fourth current mirror configured to receive the second current and coupled to the third current minor at a summing node that adds the second current to the difference current if the first current is greater than the second current.

In yet another illustrative, non-limiting embodiment, a method may include: providing a digital core and a low drop out (LDO) regulator coupled to the digital core, wherein the digital core is configured to operate in an active mode and in a standby mode; monitoring, via a current selector circuit coupled to the LDO regulator, a first current and a second current; selecting a greater of the first or second electrical currents; and providing the selected current as a biasing current to the LDO regulator. In some cases, the monitoring, selecting, and providing operations are performed as the digital core transitions between the standby mode and active modes.

### BRIEF DESCRIPTION OF THE DRAWINGS

Having thus described the invention(s) in general terms, reference will now be made to the accompanying drawings, wherein:

FIG. 1 is a block diagram of an example of a dynamic biasing circuit for a low drop out (LDO) regulator according to some embodiments.

FIG. 2 is a circuit diagram of an example of an LDO regulator architecture according to some embodiments.

FIG. 3 is a circuit diagram of an example of a current selector circuit according to some embodiments.

FIGS. 4 and 5 are graphs illustrating the transient response of an LDO regulator according to some embodiments.

FIG. 6 is a graph illustrating the current consumption of an LDO regulator according to some embodiments.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s). A person of ordinary skill in the art may be able to use the various embodiments of the invention(s).

In conventional low drop out (LDO) regulators, switching of the bias current is activated by detecting and flagging the change of state in an integrated circuit (IC). A state transition detector is used to flag the change of state in an IC by the digital core. Several modules in the IC are turned on by the digital controller as the state change is detected. This increases the current consumption on the digital core thereby increasing the load current of the LDO. The flag indicating the change of state is also used to change the bias current to the digital core targeting a superior transient response. Such an approach has several disadvantages, such as output oscillations and power-on-resets due to the abrupt change in the bias current, potentially forming a loop and placing the IC in an unexpected state of operation.

In some cases, to protect against noise, the state transition detector output is filtered. However, filtering reduces area efficiency and creates additional delay for the bias current to change.

To address these, and other problems, the techniques discussed may provide LDO regulators with dynamic biasing circuit with scalable design coefficients. As a person of ordinary skill in the art will recognize in light of this disclosure, the designs described below are readily scalable for several load currents—and it are not limited to LDOs for providing supply to digital circuits; but rather these designs are generally applicable to any LDO circuit.

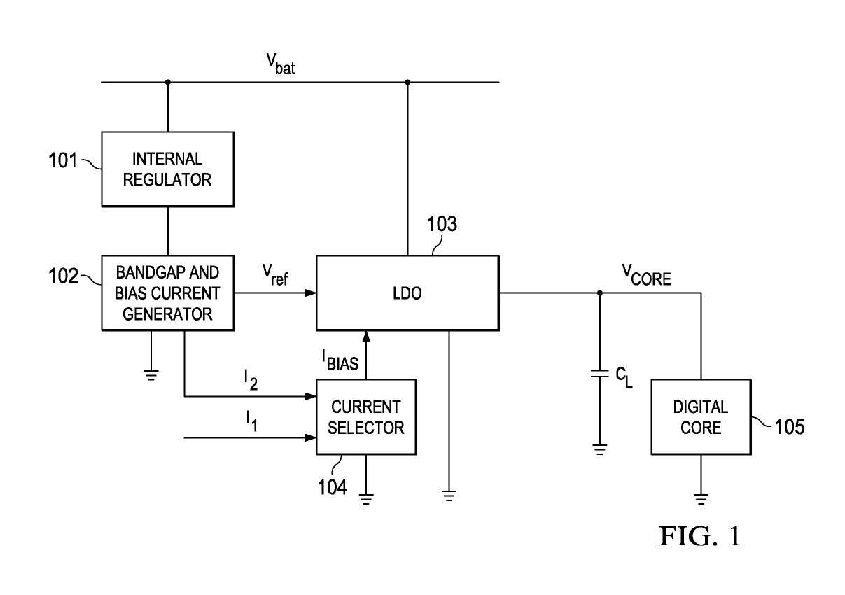

FIG. 1 is a block diagram of an example of a dynamic biasing circuit for a low drop out (LDO) regulator according to some embodiments. As shown, LDO 103 is coupled to voltage supply Vbat, which is also provided to internal regulator 101. Internal regulator 101 is coupled to bandgap and bias current generator 102, which provides reference voltage Vref to LDO 103. Current selector circuit 104 receives a first current, referred to as a standby current I₁, as well as a second current, described as active current 1₂, from bandgap and bias current generator 102. Current selector circuit 104 selects the greater of I₁ or I₂, and provides the greater one as biasing current I_{BIAS} to LDO 103. The output of LDO 103 provides V_{CORE} to digital core 105 in parallel with capacitance C_{L}.

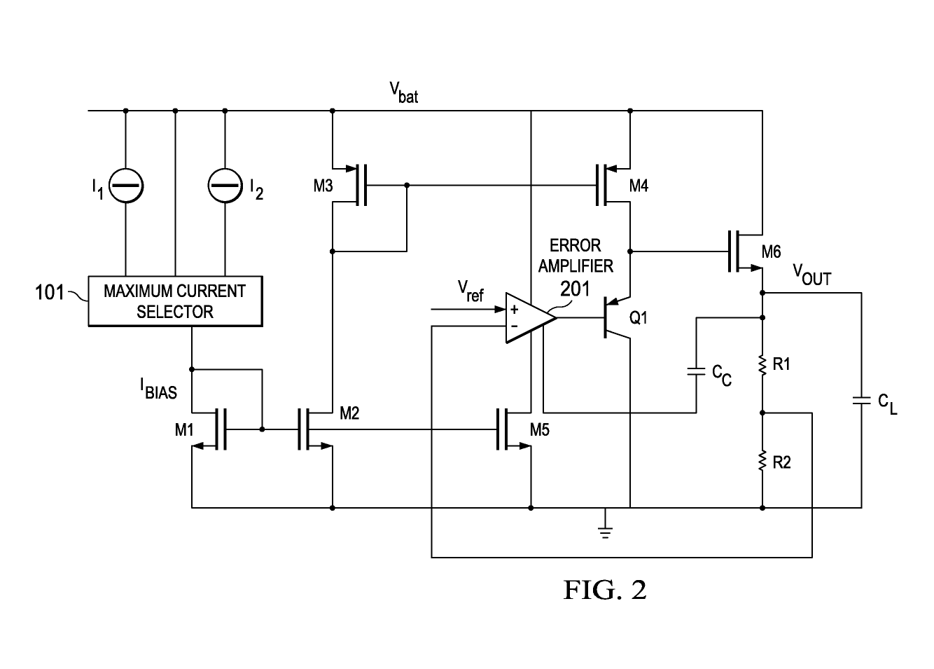

FIG. 2 is a circuit diagram of an example of an LDO regulator architecture according to some embodiments. As in FIG. 1, here current selector circuit 104 still receives both I₁ and 1₂ and selects the greater of the two currents. The selected current is provided to a node between NMOS transistors M₁ and M₂, which are in a mirror configuration. PMOS transistors M3 an M4 are also in a mirror configuration, and NMOS transistors M5 and M6 are connected as shown. Error amplifier 201 has is non-inverting input configured to receive Vref, and its inverting input is coupled to voltage divider R1/R2 at the output V_{OUT} of the LDO regulator. Another capacitor Cc is coupled between error amplifier 201 and V_{OUT}. Transistor Q1 has its emitter terminal coupled to the drain terminal of PMOS transistor M4, its base terminal coupled to the output of error amplifier 201, and its collector terminal coupled to the source terminal of NMOS transistor M5.

In operation, instead of an abrupt change in biasing I_{BIAS} current when digital core 105 switches from standby to active mode (or vice versa), the circuits of FIGS. 1 and 2 are configured to provide a gradual and high0speed transition of the bias current. This is based on current selector circuit 104, which uses selects the maximum of the bias currents I₁ and I₂ and provides it to LDO 103. Bias currents I₁ and I₂ are the inputs to the current selector. The current that is the maximum of the two is I_{BIAS}, and is used as the bias source for LDO 103.

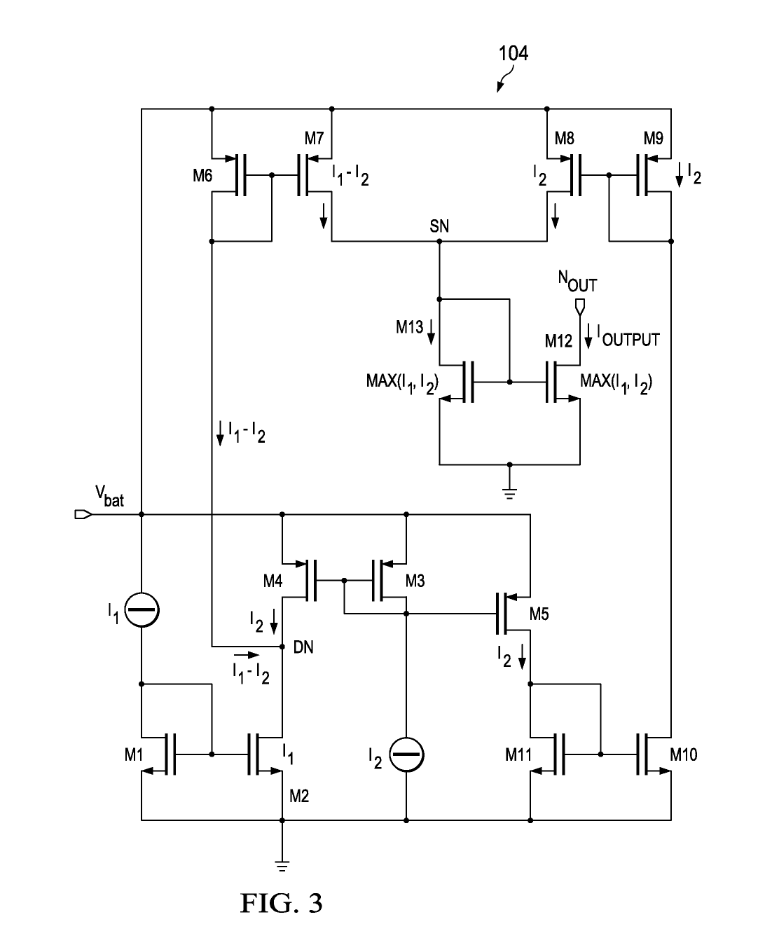

Now turning to FIG. 3, a simplified circuit diagram of current selector 104 is shown in accordance with some embodiments. Current selector 104 is generally comprised of several current mirrors (e.g., seven) and current sources I₁ and I₂. In FIG. 3, current sources I₁ and I₂ represent the current sources that provide currents also labeled I₁ and 1₂, respectively.

In operation, current selector 104 has the task of providing a bias current at its output node N_{OUT}, which corresponds to the larger of I₁ or I₂. In FIG. 3, current I₁ provided by source I₁ is mirrored by a current mirror that includes transistors M1 and M2 (e.g., NMOS FETs), and current I₂ provided by source I₂ is mirrored by two current mirrors that include transistors M3, M4, and M5 (e.g., PMOS FETs).

In this configuration, currents I₁ and I₂ are mirrored to difference node DN. Particularly, node DN provides the difference between currents I₁ and I₂, referred to as difference current (I₁−1₂). From node DN, difference current (I₁−I₂) is mirrored by a current mirror that includes transistor M6 and M7 (e.g., preferably PMOS FETs) to the summing node SN.

Furthermore, reference current I₂ (which is supplied by the current mirror that includes transistors M3 and M4) is mirrored by two current mirrors that include transistors M8 and M9 (e.g., PMOS FETs) and transistors M10 and M11 (e.g., NMOS FETs). This allows current I₂ to be provided to node SN so as to generate a bias current, which is generally the sum of difference current (I₁−I₂) and reference current I₂. The bias current is then mirrored by another current mirror that includes transistors M13 and M12 (e.g., NMOS FETs) and provide to output node NOUT.

This bias current is, thus, the sum of the difference current (I₁−I₂) and current I₂. If current I₁ is greater than current I₂, the difference current (I₁−I₂) is positive and it flows through transistor M6 in the direction indicated in FIG. 3, so the positive difference between I₁ and I₂ is added to the reference current IR to make the bias current be generally equal to I₂. If the startup current I₁ is less than the reference current I₂, difference current (I₁−I₂) would be negative; however, transistor M6 is diode-connected. Thus, a negative difference current (I₁−I₂) cannot flow through transistor M6, meaning that the bias current would generally be equal to I₂.

Accordingly, the bias current is generally equal to the larger of currents I₁ or I₂. Additionally, the target value of current I₂ can preferably be designed to be greater than the target value of I₁ so that if both currents I₁ and I₂ settle to their respective target values during a steady-state phase of the circuit 200, then the bias current generally equals current I₂. Nevertheless, if I₂ suddenly drops and the startup current I₁ is present, then the bias current assumes the value of I.

Additionally or alternatively, the gate of transistor M3 may be directly coupled to the gates of transistor M8 and M5, and transistors M11, M10 and M9 may be omitted. In this alternative configuration, however, noise may couple more easily from transistor M3 to transistor M8; that is, current mirrors M5, M11, M10, M9 provide additional noise suppression.

In summary, I₁ and I₂ are fed into the current mirror stages. The output of the current selector is Iₒᵤₜₚᵤₜ, which is the maximum value between I₁ and I₂, which is provided to LDO 103 as I_{BIAS}. In some implementations, during the standby mode of digital core 105, I₂ is approximately 0 A and during the active mode I₂ is of the order of 10 uA. Current selector circuit 104 contains several current mirrors (diode connected transistors) that are low impedance thereby avoiding delays in the change of the LDO bias current. This provides superior transient response to the LDO when the state changes from standby mode to the active mode and vice versa.

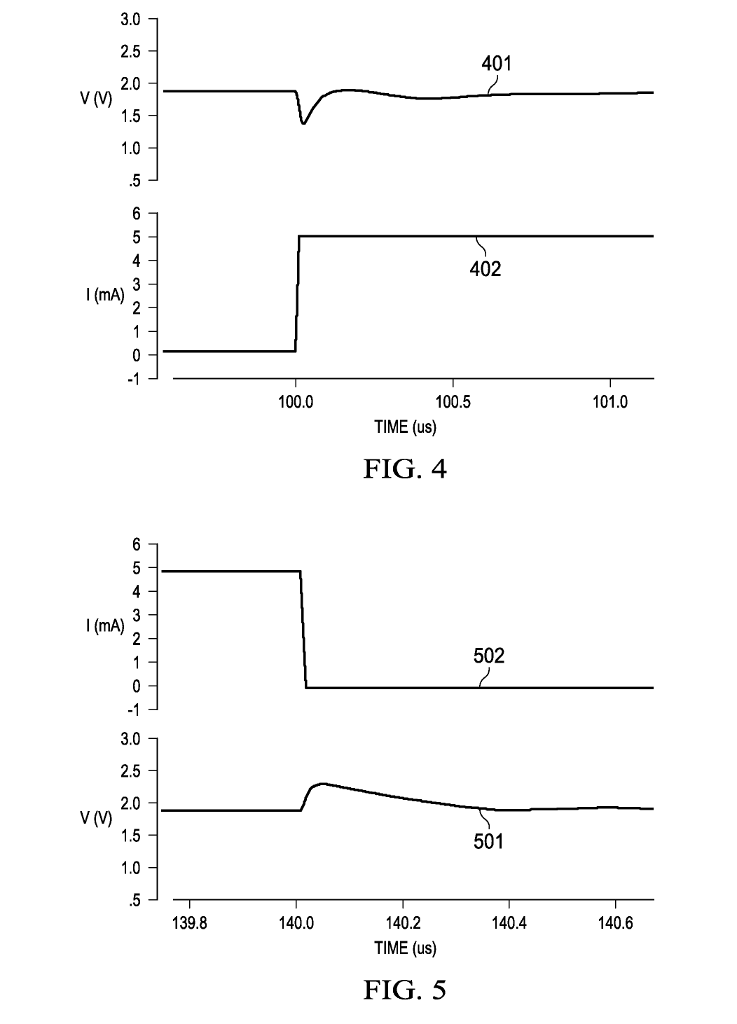

To further illustrate the foregoing, FIGS. 4 and 5 are graphs of the transient response of LDO regulator 103 in a simulated implementation. Particularly, curve 401 of FIG. 4 shows the voltage at V_{OUT} (or N_{OUT}) as the biasing current for digital core 105 transitions from 100 nA (standby mode) to 5 mA (active mode). In this case, the settling time of V_{OUT} is less than 100 ns. Conversely, curve 501 of FIG. 5 shows the voltage at V_{OUT} in the reverse direction; that is, as the biasing current for digital core 105 transitions from 5 mA (active mode) to 100 nA (standby mode). Here, the settling time of V_{OUT} is less than 200 ns.

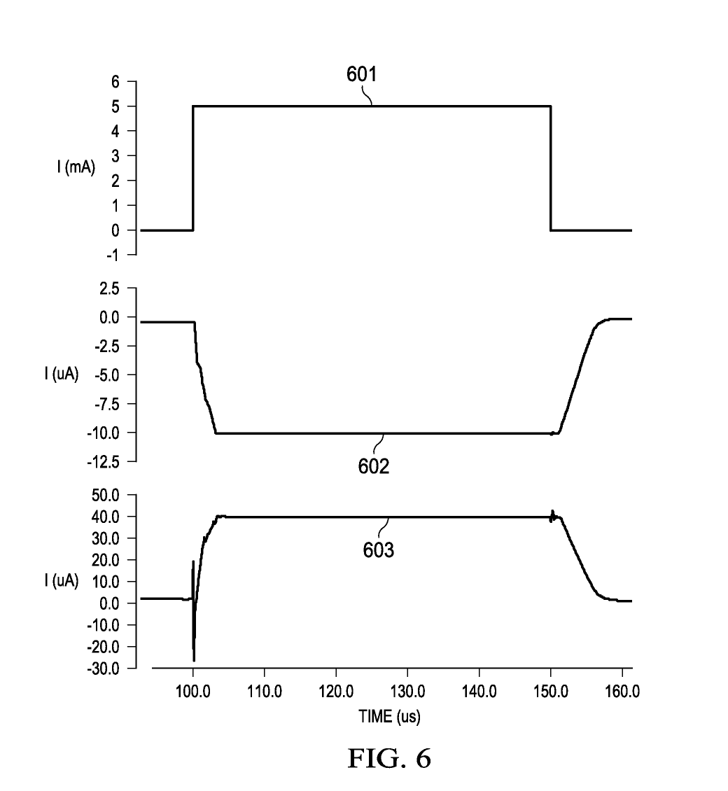

FIG. 6 is a graph of the current consumption of an LDO regulator 103 in a simulated implementation. Particularly, curve 601 shows the load current change on the LDO from 100 nA (standby) to 5 mA (active) then back to 100 nA (standby). As illustrated, curve 602 shows a gradual change in the current selector output I_{BIAS} from 100 nA to 10 μA, and curve 603 shows the LDO quiescent current consumption change from 100 nA (standby mode) to 40 μA active mode current transitioning to a 100 nA standby mode current.

The active mode load current can change across applications. For example ,some applications may need 5 mA and some may be higher to 10 mA. The load current is thereby scalable. If we also adapt scale I₂ along with the W/L of the power transistor Q1, the overall design is scalable without having any impact to the stability or to the gain. This circuit also down very well, and thereby the stability of the design is unchanged—i.e., the poles and Unity Gain bandwidth are unaltered.

As discussed herein, a dynamic biasing scheme for an LDO is provided with design scalable feature. The LDO provides gradual change of bias current leading low current consumption in standby mode and superior transient response in active mode. The current selector used in the design provides robustness against noise spikes during state transition that can lead to any unexpected state of operation of an IC. Moreover, filtering requirements are reduced or removed, thereby leading to an area efficient design.

It should be understood that the various operations described herein may be implemented by processing circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

A person of ordinary skill in the art will appreciate that the various circuits depicted above are merely illustrative and is not intended to limit the scope of the disclosure described herein. In particular, a device or system configured to perform audio power limiting based on thermal modeling may include any combination of electronic components that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other circuit configurations.

It will be understood that various operations discussed herein may be executed simultaneously and/or sequentially. It will be further understood that each operation may be performed in any order and may be performed once or repetitiously.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An electronic circuit, comprising:
a low drop out (LDO) regulator; and
a biasing circuit coupled to the LDO regulator, the biasing circuit configured to:
monitor a first electrical current and a second electrical current;
select a greater of the first or second electrical currents; and
provide the selected electrical current to the LDO regulator.

2. The electronic circuit of claim 1, further comprising a digital core coupled to the LDO regulator and configured to receive a regulated supply voltage from the LDO regulator.

3. The electronic circuit of claim 2, wherein the digital core is configured to operate in a standby mode and in an active mode.

4. The electronic circuit of claim 3, wherein when the digital core is in the standby mode it is configured to operate with the first electrical current, and wherein when the digital core is in the active mode it is configured to operate with the second electrical current.

5. The electronic circuit of claim 4, wherein the first electrical current is smaller than the second electrical current.

6. The electronic circuit of claim 5, wherein the second electrical current is of the order of 10 μA when the digital core is in the active mode, and approximately 0 A when the digital core is in the standby mode.

7. The electronic circuit of claim 1, wherein the biasing circuit includes an current selector circuit configured to receive the first electrical current and the second electrical current.

8. The electronic circuit of claim 7, wherein the current selector circuit is further configured to output the greater of the first or second electrical currents as a bias current to the LDO regulator.

9. The electronic circuit of claim 7, wherein the current selector circuit is further configured to continuously monitor the first and second electrical currents before and after the digital core transitions between the standby mode and active modes.

10. The electronic circuit of claim 8, wherein the current selector circuit further comprises:
a first current mirror configured to receive the first current;
a second current mirror coupled to the first current mirror at a difference node and configured to receive the second current;
a third current mirror coupled to the difference node and configured to receive a difference current between the first current and the second current; and
a fourth current mirror configured to receive the second current and coupled to the third current minor at a summing node that adds the second current to the difference current if the first current is greater than the second current.

11. An electronic device, comprising:
a digital core;
a low drop out (LDO) regulator coupled to the digital core; and
a selector circuit coupled to the LDO regulator, the selector circuit configured to:
monitor a first current and a second current;
select a greater of the first or second currents; and
provide the selected current as a biasing current to the LDO regulator.

12. The electronic device of claim 11, wherein when the digital core is in a standby mode it is configured to operate with the first current, and wherein when the digital core is in an active mode it is configured to operate with the second current.

13. The electronic device of claim 12, wherein the first current is smaller than the second current.

14. The electronic device of claim 12, wherein the selector circuit is further configured to continuously monitor the first and second currents before and after the digital core transitions between the standby mode and active modes.

15. The electronic device of claim 14, wherein the selector circuit further comprises:
a first current mirror configured to receive the first current;
a second current mirror coupled to the first current mirror at a difference node and configured to receive the second current;
a third current mirror coupled to the difference node and configured to receive a difference current between the first current and the second current; and
a fourth current mirror configured to receive the second current and coupled to the third current minor at a summing node that adds the second current to the difference current if the first current is greater than the second current.

16. A method, comprising:
providing a digital core and a low drop out (LDO) regulator coupled to the digital core, wherein the digital core is configured to operate in an active mode and in a standby mode;
monitoring, via a current selector circuit coupled to the LDO regulator, a first current and a second current;
selecting a greater of the first or second electrical currents; and
providing the selected current as a biasing current to the LDO regulator.

17. The method of claim 16, wherein when the digital core is in the standby mode it operates based on the first current, wherein when the digital core is in the active mode it operates based on the second current.

18. The method of claim 17, wherein the first current is smaller than the second current.

19. The method of claim 18, wherein monitoring, selecting, and providing operations are performed as the digital core transitions between the standby mode and active modes.

20. The method of claim 19, wherein the current selector circuit comprises:
a first current mirror configured to receive the first current;
a second current mirror coupled to the first current mirror at a difference node and configured to receive the second current;
a third current mirror coupled to the difference node and configured to receive a difference current between the first current and the second current; and
a fourth current mirror configured to receive the second current and coupled to the third current minor at a summing node that adds the second current to the difference current if the first current is greater than the second current.
